(19) United States
(12) Patent Application Publication
(10) Pub. No.: US 2023/0272872 A1
(43) Pub. Date: Aug. 31, 2023

(54) EXPANSION JOINT AND BALANCING DEVICE

(71) Applicant: MITSUBISHI HEAVY INDUSTRIES COMPRESSOR CORPORATION, Tokyo (JP)

(72) Inventors: Yuki Yamamoto, Hiroshima-shi (JP); Hiroyuki Miyata, Hiroshima-shi (JP); Masahiro Kobayashi, Hiroshima-shi (JP)

(73) Assignee: MITSUBISHI HEAVY INDUSTRIES COMPRESSOR CORPORATION, Tokyo (JP)

(21) Appl. No.: 18/171,791

(22) Filed: Feb. 21, 2023

(30) Foreign Application Priority Data
Feb. 25, 2022 (JP) 2022-027486

(51) Int. Cl. F16L 51/02

(52) U.S. Cl. CPC F16L 51/025

(57) ABSTRACT

An expansion joint of the present disclosure includes: a first flange disposed outside a pipe; a second flange disposed outside the pipe and is disposed away from the first flange in an axial direction of the joint; a main bellows connected to the first and second flanges and in which a flow passage of a fluid is formed; and a balancing device connected to the first and second flanges outside the main bellows and applies a thrust force opposite to a thrust force, applied to the first and second flanges in the axial direction by the main bellows, to the first and second flanges, wherein the balancing device includes a fluid supply unit, an elastic portion connected to the fluid supply unit and is allowed to expand and contract in the axial direction, and a connection portion connecting the elastic portion to the first and second flanges.

### BACKGROUND OF THE INVENTION

### Field of the Invention

The present disclosure relates to an expansion joint and a balancing device.

Priority is claimed on Japanese Patent Application No. 2022-27486, filed Feb. 25, 2022, the content of which is incorporated herein by reference.

### Description of Related Art

In some cases, a bellows connecting two pipes is used as a compressing device, gas turbine engines, and the like. The pressure of a fluid is applied to an inner surface of the bellows through which a high-pressure fluid flows. For example, Japanese Utility Model Application Publication No. 3-115290 discloses a flexible pipe which draws a part of a fluid applied to an inner surface of a bellows to a balance piston and applies the pressure of the fluid extruded by the balance piston to an outer surface of the bellows.

The flexible pipe balances the forces applied to the inner surface and the outer surface of the bellows. Accordingly, the high pressure fluid can be flowed through the flexible pipe without improving of the strength of the bellows which is performed as the conventional countermeasures.

### SUMMARY OF THE INVENTION

Similar to the flexible pipe described in Japanese Utility Model Application Publication No. 3-115290, in an expansion joint having a bellows through which a high-pressure fluid flows, the thrust force of the fluid may be applied to the bellows. Therefore, there is a possibility that an excessive load will be applied to the pipe connected to the bellows due to the thrust force of the high-pressure fluid.

The present disclosure has been made to solve the above-described problems and an object of the present disclosure is to provide an expansion joint and a balancing device capable of suppressing an excessive load from occurring in a pipe connected to a bellows by a thrust force of a fluid.

An expansion joint according to the present disclosure is an expansion joint connecting two pipes allowing a fluid to flow therethrough, the expansion joint including: a first flange which is disposed outside the pipe around a center axis; a second flange which is disposed outside the pipe around the center axis and is disposed away from the first flange in an axial direction in which the center axis extends; a main bellows which is connected to the first flange and the second flange and has a flow passage formed therein so that the fluid is able to flow therethrough; and a balancing device which is connected to the first flange and the second flange outside the bellows and applies a thrust force opposite to a thrust force, applied to the first flange and the second flange in the axial direction by the bellows, to the first flange and the second flange, wherein the balancing device includes a fluid supply unit which supplies the fluid, an elastic portion which is connected to the fluid supply unit and is able to expand and contract in the axial direction along an axis extending in parallel to the center axis according to the pressure of the supplied fluid, and a connection portion which connects the elastic portion to the first flange and the second flange.

A balancing device according to the present disclosure is a balancing device that is disposed outside an expansion joint body including a first flange which is disposed outside a pipe around a center axis, a second flange which is disposed outside the pipe around the center axis and is disposed away from the first flange in an axial direction in which the center axis extends, and a main bellows which is connected to the first flange and the second flange and has a flow passage formed therein so that a fluid is able to flow therethrough and connecting two pipes through which the fluid flows, the balancing device including: a fluid supply unit which supplies the fluid; an elastic portion which is connected to the fluid supply unit and is able to expand and contract in the axial direction along an axis extending in parallel to the center axis according to the pressure of the supplied fluid; and a connection portion which connects the elastic portion to the first flange and the second flange, wherein when the elastic portion is disposed outside the main bellows and expands and contracts, a thrust force opposite to a thrust force applied to the first flange and the second flange in the axial direction by the main bellows is applied to the first flange and the second flange.

According to the present disclosure, it is possible to provide the expansion joint and the balancing device capable of suppressing an excessive load from occurring in the pipe connected to the main bellows by the thrust force of the fluid.

### BRIEF DESCRIPTION OF THE DRAWINGS

FIG. 1 is a perspective view showing the schematic configuration of an expansion joint according to an embodiment of the present disclosure.

FIG. 2 is a partially cross-sectional view showing the structure of an expansion joint according to a first embodiment of the present disclosure.

FIG. 3 is a partially cross-sectional view showing the structure of an expansion joint according to a modified example of the first embodiment of the present disclosure.

FIG. 4 is a partially cross-sectional view showing the structure of an expansion joint according to a second embodiment of the present disclosure.

FIG. 5 is a partially cross-sectional view showing the structure of an expansion joint according to a third embodiment of the present disclosure.

### DETAILED DESCRIPTION OF THE INVENTION

Hereinafter, a mode for carrying out an expansion joint according to the present disclosure will be described with reference to the accompanying drawings.

### First Embodiment

(Expansion Joint)

An expansion joint connects together a plurality of fluid pipes (pipes) through which a high-pressure fluid flows. The expansion joint absorbs the effects of such displacement when each pipe expands or contracts in a direction in which these pipes extend. The expansion joint in this embodiment connects together two pipes arranged between scrolls in which an impeller is accommodated, for example, in a compressor or the like. The pipe is formed of, for example, metal or the like.

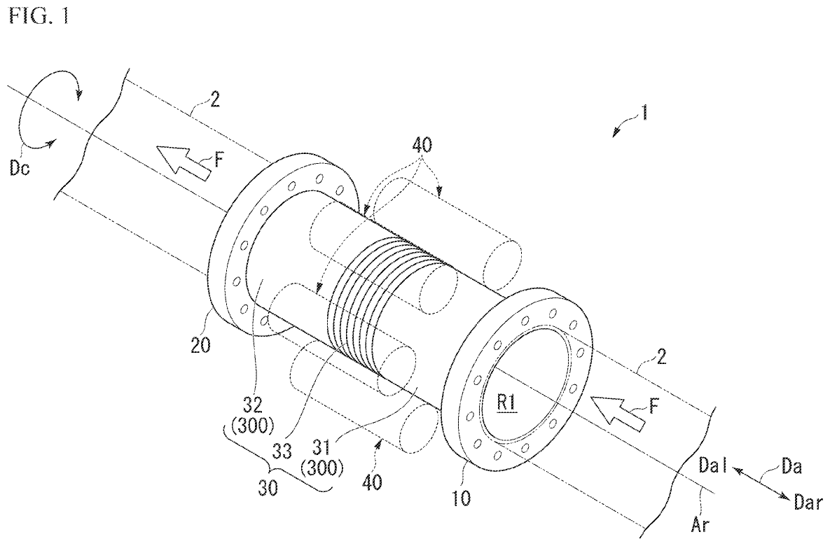

As shown in FIG. 1, an expansion joint 1 includes a main bellows 30, a first flange 10, a second flange 20, and a balancing device 40.

(Bellows)

The main bellows 30 has a cylindrical shape extending around a center axis Ar. The main bellows 30 is formed of, for example, a material such as metal. The main bellows 30 forms in a flow passage through which a fluid F can be flowed. Hereinafter, the extension direction of the center axis Ar is referred to as the “axial direction Da”. Further, one side in the axial direction Da is simply referred to as “one side Dar” and the other side is simply referred to as the “other side Dal”. Further, the circumferential direction with respect to the center axis Ar is simply referred to as the “circumferential direction Dc” and the direction perpendicular to the center axis Ar is referred to as the “radial direction”.

The main bellows 30 includes two straight pipe portions 300 and a bellows portion 33. Two straight pipe portions 300 and the bellows portion 33 are arranged side by side in the axial direction Da. Specifically, one straight pipe portion 300, the bellows portion 33, and the other straight pipe portion 300 are arranged in this order in the axial direction Da and are integrated by being connected to each other. Hereinafter, for convenience of description, the straight pipe portion 300 disposed on one side Dar in relation to the bellows portion 33 is referred to as a “first straight pipe portion 31” and the straight pipe portion 300 disposed on the other side Dal in relation to the bellows portion 33 is referred to as a “second straight pipe portion 32”.

The first straight pipe portion 31 and the second straight pipe portion 32 are straight pipes extending around the center axis Ar. The first straight pipe portion 31 and the second straight pipe portion 32 are formed to have the same size. The term “same size” used herein refers to substantially the same shape, and slight manufacturing errors and design tolerances are allowed. Here, a pipe 2 is connected to the end portion on one side Dar of the first straight pipe portion 31. The pipe 2 is connected to the end portion on the other side Dal of the second straight pipe portion 32.

The bellows portion 33 is a pipe forming a bellows cylindrical shape. The bellows portion 33 is disposed between the first straight pipe portion 31 and the second straight pipe portion 32. The end portion on one side Dar of the bellows portion 33 is connected to the end portion on the other side Dal of the first straight pipe portion 31. The end portion on the other side Dal of the bellows portion 33 is connected to the end portion on one side Dar of the second straight pipe portion 32. Hereinafter, for convenience of description, the space formed inside the first straight pipe portion 31, the second straight pipe portion 32, and the bellows portion 33, that is, the flow passage formed inside the main bellows 30 in which the fluid F can be flowed is referred to as a “first space R1”.

(First Flange)

The first flange 10 has a disc shape centered on the center axis Ar. The first flange 10 is connected to the main bellows 30. Specifically, the first flange 10 is formed integrally to cover the end portion on one side Dar of the outer peripheral surface of the first straight pipe portion 31 from the outside. Thus, the first flange 10 has a flange shape that spreads from the first straight pipe portion 31 of the main bellows 30 outward in the radial direction. That is, the first flange 10 is disposed outside the pipe 2. The first flange 10 is formed of, for example, a material such as metal.

(Second Flange)

The second flange 20 has a disc shape centered on the center axis Ar. The second flange 20 is connected to the main bellows 30. Specifically, the second flange 20 is formed integrally to cover the end portion on the other side Dal of the outer peripheral surface of the second straight pipe portion 32 from the outside. Thus, the first flange 10 has a flange shape that spreads from the second straight pipe portion 32 of the main bellows 30 outward in the radial direction. The second flange 20 is disposed apart from the first flange 10 in the axial direction Da. That is, the second flange 20 is disposed outside the pipe 2. The surface facing one side Dar in the second flange 20 faces the surface facing the other side Dal of the first flange 10 in the axial direction Da.

Thus, the fluid F flowing through the pipe 2 connected to the first flange 10 flows from one side Dar into the first space R1 (flow passage) inside the main bellows 30. The fluid F flowing through the first space R1 in the axial direction Da flows into the pipe 2 connected to the second flange 20.

Additionally, the first flange 10 and the second flange 20 are not limited to being formed integrally with the first straight pipe portion 31 and the second straight pipe portion 32. In the first flange 10 and the second flange 20, the first straight pipe portion 31 and the second straight pipe portion 32 may be formed as different members and the first straight pipe portion 31 and the second straight pipe portion 32 may be respectively fixed.

(Balancing Device)

The balancing device 40 is disposed between the first flange 10 and the second flange 20. The balancing device 40 is connected to the first flange 10 and the second flange 20. The balancing device 40 is a device that applies a thrust force opposite to the thrust force of the fluid F applied to the first flange 10 and the second flange 20 in the axial direction Da due to the expansion and contraction of the main bellows 30 in the axial direction Da to the first flange 10 and the second flange 20.

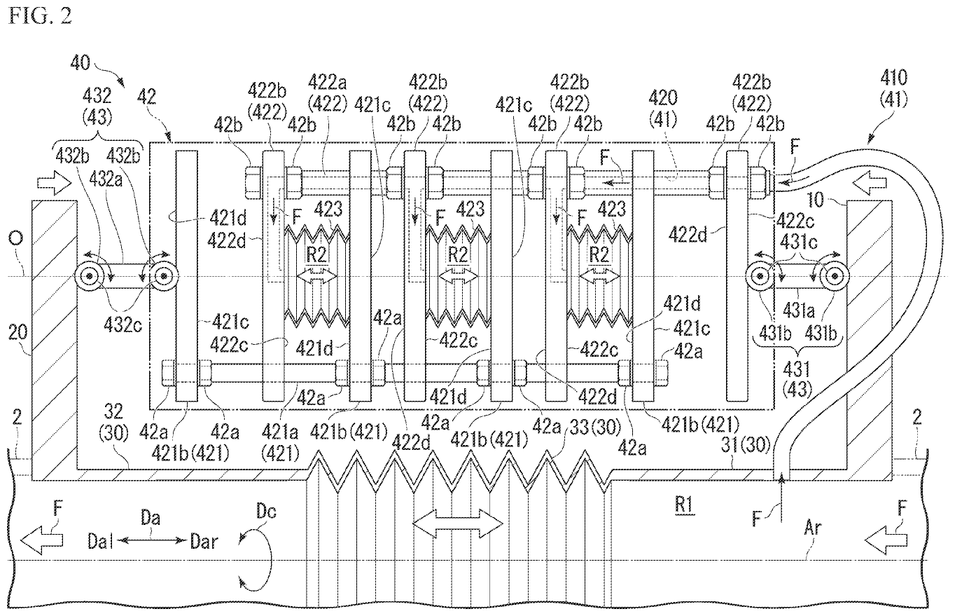

As shown in FIG. 1, the plurality of balancing devices 40 are arranged outside the main bellows 30 apart from each other in the circumferential direction Dc centered on the center axis Ar. That is, the plurality of balancing devices 40 are arranged in the circumferential direction Dc. As shown in FIG. 2, the balancing device 40 includes an elastic portion 42, a connection portion 43, and a fluid supply unit 41.

(Elastic Portion)

The elastic portion 42 expands and contracts in the axial direction Da between the first flange 10 and the second flange 20. The elastic portion 42 is supplied with the fluid F from the outside and can be expanded and contracted in the axial direction Da according to the pressure of the supplied fluid F. The elastic portion 42 includes a first structure 421, a second structure 422, a small bellows 423, a first fixing nut 42a, and a second fixing nut 42b.

(First Structure)

The first structure 421 is configured by combining a plurality of members. The first structure 421 is formed of, for example, a material such as metal. The first structure 421 includes a plurality of first plate portions 421b which are arranged side by side in the axial direction Da and a first support column 421a which integrates the plurality of first plate portions 421b in the axial direction Da.

The first plate portion 421b is a disc-shaped member extending around the axis O extending in parallel to the center axis Ar. The axis O is disposed on the outside of the center axis Ar in the radial direction. The term “parallel” used herein means a substantially parallel relationship, and a slight inclination or the like is allowed if the relationship is substantially parallel.

In this embodiment, four first plate portions 421b are arranged side by side at intervals in the axial direction Da. These first plate portions 421b are arranged at equal intervals in the axial direction Da. Each first plate portion 421b includes a first surface 421c which faces one side Dar and a second surface 421d which faces the other side Dal. Thus, the second surface 421d of the first plate portion 421b on one side Dar in two first plate portions 421b adjacent to each other in the axial direction Da faces the first surface 421c of the first plate portion 421b on the other side Dal in the axial direction Da.

The first support column 421a extends in the axial direction Da while penetrating each first plate portion 421b. Specifically, the first support column 421a penetrates the inner radial portion of each first plate portion 421b. The inner radial portion of the first plate portion 421b referred to here means a portion disposed on the inside in the radial direction when the first plate portion 421b is bisected in the radial direction with respect to the center axis Ar. Further, the outer radial portion of the first plate portion 421b means a portion disposed on the outside in the radial direction when the first plate portion 421b is bisected in the radial direction with respect to the center axis Ar.

The first support column 421a is fixed to each first plate portion 421b by the first fixing nut 42a. Specifically, two first fixing nuts 42a are fitted to thread grooves (not shown) formed in the first support column 421a while sandwiching the first plate portion 421b therebetween. The first fixing nut 42a disposed on one side Darin two first fixing nuts 42a adjacent to each other while sandwiching the first plate portion 421b therebetween presses the first plate portion 421b to the other side Dal while coming into contact with the first surface 421c of the first plate portion 421b. The first fixing nut 42a disposed on the other side Dal in two first fixing nuts 42a adjacent to each other while sandwiching the first plate portion 421b therebetween presses the first plate portion 421b to one side Dar while coming into contact with the second surface 421d of the first plate portion 421b. Accordingly, each first plate portion 421b is restricted not to move in the axial direction Da by two first fixing nuts 42a adjacent to each other while sandwiching the first plate portion 421b. Thus, eight first fixing nuts 42a are fitted to the first support column 421a of this embodiment.

(Second Structure)

The second structure 422 is configured by combining a plurality of members similarly to the first structure 421. The second structure 422 is formed of, for example, a material such as metal. The second structure 422 includes a plurality of second plate portions 422b which are arranged side by side in the axial direction Da and a second support column 422a which integrates the plurality of second plate portions 422b in the axial direction Da.

The second plate portion 422b is a circular member that spreads around the axis O. The radial dimension of the second plate portion 422b about the axis O is the same as the radial dimension of the first plate portion 421b about the axis O. The term “same” used herein means substantially the same length, and slight manufacturing errors and design tolerances are allowed.

In this embodiment, four second plate portions 422b are arranged side by side at intervals in the axial direction Da. These second plate portions 422b are arranged at equal intervals in the axial direction Da. Here, the first plate portion 421b and the second plate portion 422b are alternately arranged in the axial direction Da. The first plate portion 421b disposed on the most one side Dar among the plurality of first plate portions 421b is sandwiched between the second plate portion 422b disposed on the most one side Dar and the second plate portion 422b adjacent to this second plate portion 422b from the other side Dal with a gap therebetween. The second plate portion 422b disposed on the most other side Dal among the plurality of second plate portions 422b is sandwiched between the first plate portion 421b disposed on the most other side Dal and the first plate portion 421b adjacent to this first plate portion 421b from one side Dar with a gap therebetween.

Each second plate portion 422b includes one surface 422c facing one side Dar and the other surface 422d facing the other side Dal. Thus, one surface 422c of each second plate portion 422b except for the second plate portion 422b disposed on the most one side Dar faces the second surface 421d of the first plate portion 421b, adjacent thereto in the axial direction Da, in the axial direction Da and the other surface 422d of each second plate portion 422b except for the second plate portion 422b disposed on the most one side Dar faces the first surface 421c of the first plate portion 421b, adjacent thereto in the axial direction Da, in the axial direction Da.

The other surface 422d of the second plate portion 422b disposed on the most one side Dar faces the first surface 421c of the first plate portion 421b disposed on the most one side Dar in the axial direction Da and one surface 422c of this second plate portion 422b faces the first flange 10 in the axial direction Da. The second surface 421d of the first plate portion 421b disposed on the most other side Dal faces the second flange 20 in the axial direction Da.

The second support column 422a extends in the axial direction Da while penetrating each second plate portion 422b. Specifically, the second support column 422a penetrates the outer radial portion of each second plate portion 422b. The outer radial portion of the second plate portion 422b referred to here means a portion disposed on the outside in the radial direction when the second plate portion 422b is bisected in the radial direction with respect to the center axis Ar. Further, the inner radial portion of the second plate portion 422b means a portion disposed on the inside in the radial direction when the second plate portion 422b is bisected in the radial direction with respect to the center axis Ar.

The second support column 422a is fixed to each second plate portion 422b by the second fixing nut 42b. Specifically, two second fixing nuts 42b are fitted to thread grooves (not shown) formed in the second support column 422a while sandwiching the second plate portion 422b. The second fixing nut 42b disposed on one side Dar in two second fixing nuts 42b adjacent to each other while sandwiching the second plate portion 422b presses the second plate portion 422b to the other side Dal while coming into contact with one surface 422c of the second plate portion 422b. The second fixing nut 42b disposed on the other side Dal in two second fixing nuts 42b adjacent to each other while sandwiching the second plate portion 422b presses the second plate portion 422b to one side Dar while coming into contact with the second surface 421d of the second plate portion 422b. Accordingly, each second plate portion 422b is restricted not to move in the axial direction Da by two second fixing nuts 42b adjacent to each other while sandwiching the second plate portion 422b. Thus, eight second fixing nuts 42b are fitted to the second support column 422a of this embodiment.

Here, the first support column 421a penetrates each second plate portion 422b to be movable in the axial direction Da with respect to each second plate portion 422b except for the second plate portion 422b disposed on the most one side Dar in the plurality of second plate portions 422b. Specifically, the first support column 421a penetrates the inner radial portion of each second plate portion 422b in the axial direction Da. Further, the second support column 422a penetrates each first plate portion 421b to be movable in the axial direction Da with respect to each first plate portion 421b except for the first plate portion 421b disposed on the most other side Dal in the plurality of first plate portions 421b. Specifically, the second support column 422a penetrates the outer radial portion of each first plate portion 421b in the axial direction Da.

(Small Bellows)

The small bellows 423 is disposed between the first plate portion 421b except for the first plate portion 421b disposed on the most other side Dal in the first structure 421 and the second plate portion 422b adjacent to this first plate portion 421b from the other side Dal. That is, in this embodiment, three small bellows 423 are arranged between the first plate portion 421b and the second plate portion 422b. The small bellows 423 has a bellows cylindrical shape extending around the axis O. The small bellows 423 is formed of, for example, a material such as metal. The small bellows 423 is formed in a space into which the fluid F is supplied. Hereinafter, for convenience of description, the space inside the small bellows 423 is referred to as a “second space R2”. This second space R2 is a space into which the fluid F is supplied from the first space R1. The small bellows 423 is formed to be smaller than the main bellows 30.

The small bellows 423 connects the first plate portion 421b and the second plate portion 422b to each other. The opening facing one side Darin the small bellows 423 is fixed to the second surface 421d of the first plate portion 421b. The opening facing one side Dar of the small bellows 423 is fixed to the second surface 421d so that the center of the opening matches the center of the second surface 421d. The opening facing the other side Dal of the small bellows 423 is fixed to one surface 422c of the second plate portion 422b. This opening facing the other side Dal of the small bellows 423 is fixed to one surface 422c so that the center of the opening matches the center of one surface 422c.

(Connection Portion)

The connection portion 43 connects the elastic portion 42 to the first flange 10 and the second flange 20. The connection portion 43 is formed of, for example, a material such as metal. The connection portion 43 includes a first connection portion 431 which connects together the first flange 10 and the elastic portion 42, and a second connection portion 432 which connects together the second flange 20 and the elastic portion 42.

(First Connection Portion)

The first connection portion 431 connects together the first flange 10 and the elastic portion 42. The first connection portion 431 includes a first arm portion 431a (arm portion) which extends in the axial direction Da and a first joint portion 431b (joint portion) which rotatably supports the first arm portion 431a.

The first arm portion 431a has a columnar shape. The first arm portion 431a is disposed between the first flange 10 and the elastic portion 42. The first joint portion 431b is a universal joint that is connected to each of the end portion on one side Dar of the first arm portion 431a and the end portion on the other side Dal of the first arm portion 431a.

Although the illustration of detailed configuration is omitted, each first joint portion 431b includes a first rotating shaft 431c (rotating shaft) which extends in a direction intersecting the axial direction Da. The first rotating shaft 431c of the first joint portion 431b of this embodiment extends in a direction perpendicular to the axial direction Da. In addition, “perpendicular” here means a substantially perpendicular relationship, and a slight inclination or the like is allowed in a substantially perpendicular relationship. The first rotating shaft 431c of the first joint portion 431b is connected to the first arm portion 431a. The first joint portion 431b supports the first arm portion 431a to be rotatable around the first rotating shaft 431c by the first rotating shaft 431c.

In two first joint portions 431b connected to the first arm portion 431a, the first joint portion 431b disposed on one side Dar is connected to the first flange 10. In two first joint portions 431b connected to the first arm portion 431a, the first joint portion 431b disposed on the other side Dal is connected to the second plate portion 422b disposed on the most one side Dar in the second structure 422. Specifically, this first joint portion 431b is connected to the center portion of one surface 422c of the second plate portion 422b.

(Second Connection Portion)

The second connection portion 432 connects together the second flange 20 and the elastic portion 42. The second connection portion 432 includes a second arm portion 432a (arm portion) which extends in the axial direction Da and a second joint portion 432b (joint portion) which rotatably supports the second arm portion 432a.

The second arm portion 432a has a columnar shape. The second arm portion 432a is disposed between the second flange 20 and the elastic portion 42. The second joint portion 432b is a universal joint that is connected to each of the end portion on one side Dar of the second arm portion 432a and the end portion on the other side Dal of the second arm portion 432a.

Although the illustration of detailed configuration is omitted, each second joint portion 432b has a second rotating shaft 432c (rotating shaft) extending in a direction intersecting the axial direction Da. The second rotating shaft 432c of the second joint portion 432b of this embodiment extends in a direction perpendicular to the axial direction Da. In addition, “perpendicular” here means a substantially perpendicular relationship, and a slight inclination or the like is allowed in a substantially perpendicular relationship. The second rotating shaft 432c of the second joint portion 432b is connected to the second arm portion 432a. The second joint portion 432b supports the first arm portion 431a to be rotatable around the second rotating shaft 432c by the second rotating shaft 432c.

In two second joint portions 432b connected to the second arm portion 432a, the second joint portion 432b disposed on one side Dar is connected to the second flange 20. In two second joint portions 432b connected to the second arm portion 432a, the second joint portion 432b disposed on the other side Dal is connected to the first plate portion 421b disposed on the most other side Dal in the first structure 421. Specifically, this second joint portion 432b is connected to the center portion of the second surface 421d of the first plate portion 421b.

(Fluid Supply Unit)

The fluid supply unit 41 supplies the fluid F flowing through the first space R1 into the second space R2. The fluid supply unit 41 connects together the first space R1 and the second space R2. The fluid supply unit 41 of this embodiment includes a flexible and bendable tube member 410 and a fluid passage 420.

The tube member 410 is formed of, for example, rubber, synthetic resin, or the like. The tube member 410 connects the first straight pipe portion 31 of the main bellows 30 to the second support column 422a of the second structure 422 of the elastic portion 42. One end of the tube member 410 is connected to the first straight pipe portion 31 so that the fluid F can be introduced from the first space R1 into the tube member 410. The other end of the tube member 410 is connected to the end portion (end surface) on one side Dar of the second support column 422a of the second structure 422.

Here, the fluid passage 420 which allows to supply the fluid F supplied from the tube member 410 into the second space R2 is formed in the second structure 422. Specifically, the fluid passage 420 is formed inside the second plate portion 422b except for the second support column 422a and the second plate portion 422b disposed on the most one side Dar. The fluid passage 420 formed inside the second support column 422a and the fluid passage 420 formed inside the second plate portion 422b are connected to each other.

One end of the fluid passage 420 opens, for example, at the end surface on one side Dar of the second support column 422a. One end of the fluid passage 420 is connected to the other end of the tube member 410. When starting from one end of the fluid passage 420 formed on the end surface on one side Dar of the second support column 422a, the fluid passage 420 is branched into three parts in the middle and the other ends of the three branched ends open to one surface 422c of each second plate portion 422b. Specifically, the other ends of the fluid passages 420 open at the center portion of one surface 422c of the second plate portion 422b.

Thus, the tube member 410 and the fluid passage 420 formed inside the second structure 422 are provided. By the fluid supply unit 41, the first space R1 and the second space R2 communicate with each other. The fluid F flowing through the first space R1 flows into the tube member 410 and then flows into the fluid passage 420 formed inside the second structure 422. The fluid F flowing from the tube member 410 into the fluid passage 420 flows into the second space R2.

### Action and Effect

The main bellows 30 may extend in the axial direction Da by the thrust force in the axial direction Da of the high-pressure fluid F flowing through the first space R1. Depending on the magnitude of the thrust force, an excessive load may be applied to the pipe 2 connected to the main bellows 30 and the pipe 2 may be damaged. At this time, a force directed to one side Dar is applied to the first flange 10 connected to the main bellows 30 and a force directed to the other side Dal is applied to the second flange 20 connected to the main bellows 30. That is, a thrust force in the axial direction Da is applied to the first flange 10 and the second flange 20 by the main bellows 30.

According to the above-described configuration, a part of the fluid F flowing through the first space R1 is supplied into the second space R2 through the fluid supply unit 41. When the fluid F is supplied into the second space R2, the small bellows 423 expands in the axial direction Da. As the small bellows 423 expands, each first plate portion 421b connected to the small bellows 423 is pressed to one side Dar. As these first plate portions 421b are pressed to one side Dar, the first support column 421a that integrates the plurality of first plate portions 421b is pulled to one side Dar. Accordingly, the first plate portion 421b which is connected to the first support column 421a and is disposed on the most other side Dal is pulled to one side Dar and the second connection portion 432 connected to this first support column 421a is pulled to one side Dar at the same. As a result, the second flange 20 connected to the second connection portion 432 is pulled to one side Dar.

On the other hand, as the small bellows 423 expands, each second plate portion 422b connected to the small bellows 423 is pressed to the other side Dal. As these second plate portions 422b are pressed to the other side Dal, the second support column 422a that integrates the plurality of second plate portion 422b is pulled to the other side Dal. Accordingly, the second plate portion 422b which is connected to the second support column 422a and is disposed on the most one side Dar is pulled to one side Dar and the first connection portion 431 connected to this second support column 422a is pulled to the other side Dal at the same. As a result, the first flange 10 connected to the first connection portion 431 is pulled to the other side Dal.

That is, the fluid F is supplied from the first space R1 to the second space R2 and the elastic portion 42 of the balancing device 40 expands and contracts in the axial direction Da, so that the first flange 10 is pulled to the other side Dal and the second flange 20 is pulled to one side Dar. That is, a thrust force opposite to the above-described thrust force is applied to the first flange 10 and the second flange 20 due to the balancing device 40.

Accordingly, the magnitude of the thrust force applied to the first flange 10 and the second flange 20 by the main bellows 30 and the magnitude of the opposite thrust force applied to the first flange 10 and the second flange 20 by the balancing device 40 can be balanced. That is, the main bellows 30 is suppressed from extending in the axial direction Da by the thrust force of the fluid F flowing through the first space R1. Thus, it is possible to prevent excessive load from being applied to the pipe 2 connected to the main bellows 30 due to the thrust force of the fluid F.

Further, vibration or the like occurs in the main bellows 30 due to the flow of the fluid F in the first space R1, and the main bellows 30 may be displaced in a direction perpendicular to the axial direction Da.

According to the above-described configuration, the first connection portion 431 includes the first joint portion 431b which rotatably supports the first arm portion 431a by the first rotating shaft 431c and the second connection portion 432 includes the second joint portion 432b which rotatably supports the second arm portion 432a by the second rotating shaft 432c.

Therefore, the first arm portion 431a is rotated by the first joint portion 431b and the second arm portion 432a is rotated by the second joint portion 432b to follow the displacement of the main bellows 30. Thus, the main bellows 30 is less susceptible to the weight of the elastic portion 42 compared to, for example, a configuration in which the elastic portion 42 is connected to the first flange 10 and the second flange 20 not to be displaceable. As a result, the main bellows 30 can be displaced more freely.

Further, even when the elastic portion 42 of the balancing device 40 expands and contracts in a direction inclined with respect to the axial direction Da (a direction intersecting the axial direction Da), the first rotating shaft 431c and the second rotating shaft 432c rotate to correspond to the inclination of the elastic portion 42 and the elastic portion 42 can be freely expanded and contracted while being inclined with respect to the axial direction Da. Thus, the occurrence of stress in the balancing device 40 can be suppressed.

### Modified Example of First Embodiment

Additionally, the configuration of the elastic portion 42 of the balancing device 40 is not limited to the configuration of the first embodiment. The elastic portion 42 is connected to the fluid supply unit 41 and can be expanded and contracted in the axial direction Da along the axis O according to the pressure of the supplied fluid F. As a modified example of the elastic portion 42, for example, the following configuration is also possible.

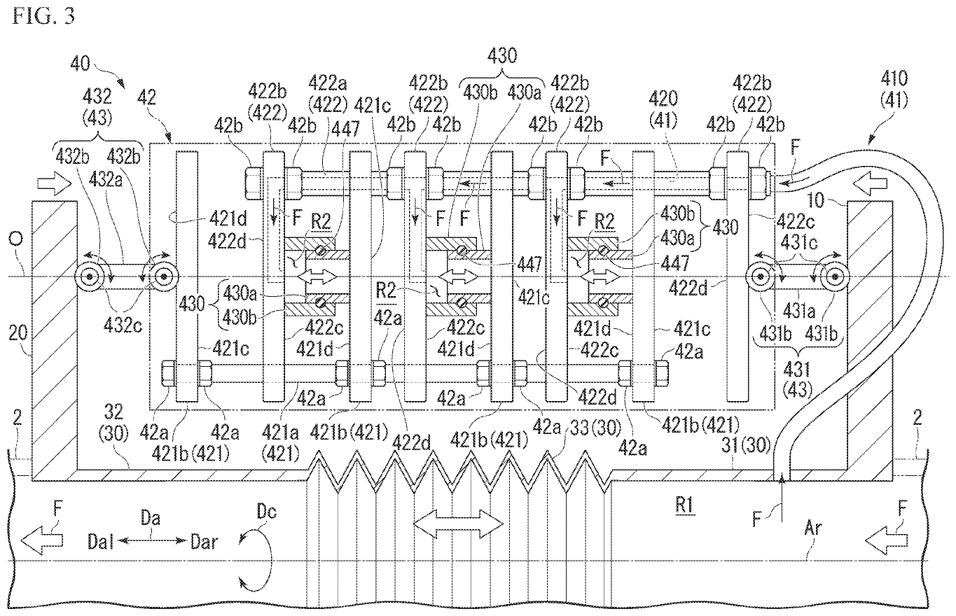

As shown in FIG. 3, the elastic portion 42 includes the first structure 421, the second structure 422, a piston section 430, the first fixing nut 42a, and the second fixing nut 42b. That is, the elastic portion 42 includes the piston section 430 instead of the small bellows 423. Since the first structure 421, the second structure 422, the first fixing nut 42a, and the second fixing nut 42b have the same configurations as those of the first embodiment, a description thereof will be omitted.

(Piston Section)

The piston section 430 is disposed between the first plate portion 421b except for the first plate portion 421b disposed on the most other side Dal in the first structure 421 and the second plate portion 422b adjacent to this first plate portion 421b from the other side Dal. That is, in this modified example, three piston sections 430 are arranged between the first plate portion 421b and the second plate portion 422b.

The piston section 430 includes an inner pipe 430a, an outer pipe 430b, and a sealing portion 447. The inner pipe 430a has a cylindrical shape extending around the axis O. The inner pipe 430a is connected to the second surface 421d of the first plate portion 421b. The inner pipe 430a is fixed to the second surface 421d so that the center of the opening on one side Dar of the inner pipe 430a matches the center of the second surface 421d.

The outer pipe 430b has a cylindrical shape extending around the axis O. The outer pipe 430b covers the inner pipe 430a from the outside while being connected to one surface 422c of the second plate portion 422b. The inner peripheral surface of the outer pipe 430b is in sliding contact with the outer peripheral surface of the inner pipe 430a. The outer pipe 430b is fixed to one surface 422c so that the center of the opening on the other side Dal of the outer pipe 430b matches the center of one surface 422c. Here, the other end of the fluid passage 420 of the fluid supply unit 41 opens at the center portion of one surface 422c of the second plate portion 422b.

The sealing portion 447 is a sealing member that airtightly isolates the inside of the inner pipe 430a and the inside of the outer pipe 430b from the atmosphere. The sealing portion 447 is disposed between the inner pipe 430a and the outer pipe 430b. The sealing portion 447 is an annular member centered on the axis O. The sealing portion 447 is an elastic body. For example, an O-ring or the like is adopted for the sealing portion 447. The sealing portion 447 comes into contact with each of the outer peripheral surface of the inner pipe 430a and the inner peripheral surface of the outer pipe 430b. In this modified example, the second space R2 is formed inside by the inner pipe 430a, the outer pipe 430b, and the sealing portion 447 disposed therebetween. The fluid F is supplied from the first space R1 to the second space R2 through the fluid supply unit 41.

### Action and Effect

According to the above-described configuration, a part of the fluid F flowing through the first space R1 is supplied to the second space R2 through the fluid supply unit 41. When the fluid F is supplied into the second space R2, the inner pipe 430a and the outer pipe 430b are displaced away from each other in the axial direction Da while being in sliding contact with each other. That is, the piston section 430 expands in the axial direction Da. As the piston section 430 expands, each first plate portion 421b connected to the inner pipe 430a is pressed to one side Dar. As these first plate portions 421b are pressed to one side Dar, the first support column 421a that integrates the plurality of first plate portions 421b is pulled to one side Dar. Accordingly, the first plate portion 421b which is connected to the first support column 421a and is disposed on the most other side Dal is pulled to one side Dar and the second connection portion 432 connected to this first support column 421a is pulled to one side Dar at the same. As a result, the second flange 20 connected to the second connection portion 432 is pulled to one side Dar.

On the other hand, as the piston section 430 expands, each second plate portion 422b connected to the outer pipe 430b is pressed to the other side Dal. As these second plate portions 422b are pressed to the other side Dal, the second support column 422a that integrates the plurality of second plate portion 422b is pulled to the other side Dal. Accordingly, the second plate portion 422b which is connected to the second support column 422a and is disposed on the most one side Dar is pulled to one side Dar and the first connection portion 431 connected to this second support column 422a is pulled to the other side Dal at the same. As a result, the first flange 10 connected to the first connection portion 431 is pulled to the other side Dal. Accordingly, the same effects as those of the first embodiment are obtained.

### Second Embodiment

Next, a second embodiment of the expansion joint 1 according to the present disclosure will be described. Additionally, in the second embodiment described below, the configurations common to the first embodiment and the modified example of the first embodiment are denoted by the same reference numerals in the drawings, and a description thereof will be omitted. In the second embodiment, the configuration of the balancing device 40 is different from the configuration of the balancing device 40 described in the first embodiment and the modified example of the first embodiment.

(Balancing Device)

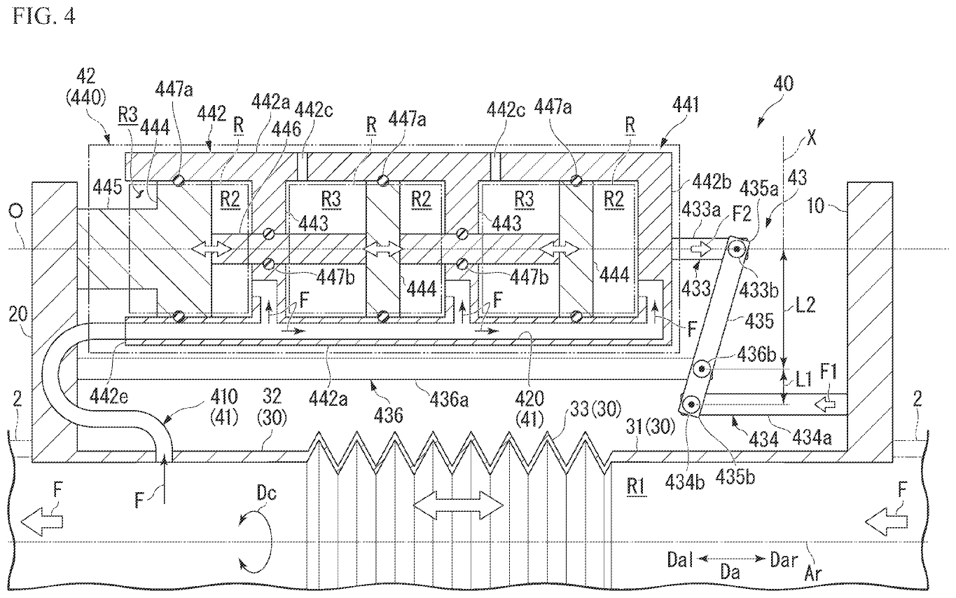

As shown in FIG. 4, the balancing device 40 includes the elastic portion 42, the connection portion 43, and the fluid supply unit 41.

(Elastic Portion)

The elastic portion 42 expands and contracts in the axial direction Da between the first flange 10 and the second flange 20. The elastic portion 42 is supplied with the fluid F from the outside. The elastic portion 42 can be expanded and contracted in the axial direction Da according to the pressure of the supplied fluid F. The elastic portion 42 includes a piston section 440.

(Piston Section)

The piston section 440 is disposed between the first flange 10 and the second flange 20. The piston section 440 includes a cylinder portion 441, a piston portion 444, a piston connection portion 445, a rod portion 446, a first sealing portion 447a, and a second sealing portion 447b.

(Cylinder Portion)

The cylinder portion 441 has a bottomed cylindrical shape centered on the axis O. The inside of the cylinder portion 441 is defined into a plurality of spaces. The cylinder portion 441 includes a main body portion 442 and a partition portion 443. The main body portion 442 includes a side portion 442a which has a cylindrical shape centered on the axis O and a bottom portion 442b which is formed integrally with the side portion 442a to close the opening facing one side Dar of the side portion 442a and spreads in a disc shape around the axis O. Thus, the cylinder portion 441 has an opening facing the other side Dal. The opening opens to the atmosphere.

The plurality of partition portions 443 are arranged at intervals in the axial direction Da inside the main body portion 442. In this embodiment, two partition portions 443 are arranged side by side in the axial direction Da. The partition portion 443 has a disc shape that spreads around the axis O. The partition portion 443 spreads in parallel to the bottom portion 442b of the main body portion 442. The term “parallel” used herein means a substantially parallel relationship, and a slight inclination or the like is allowed if the relationship is substantially parallel. The partition portion 443 is integrally fixed to the inner peripheral surface of the side portion 442a of the main body portion 442.

The surface facing one side Dar of the partition portion 443 disposed on one side Dar in two partition portions 443 and the surface facing the other side Dal of the bottom portion 442b face each other. The surface facing the other side Dal of the partition portion 443 disposed on one side Dar in two partition portions 443 and the surface facing one side Dar of the partition portion 443 disposed on the other side Dal in two partition portions 443 face each other. The surface facing the other side Dal of this partition portion 443 faces the surface facing one side Dar of the second flange 20. Thus, the inside of the main body portion 442 of this embodiment is defined into three spaces R which are arranged side by side in the axial direction Da by two partition portions 443.

(Piston Portion)

The piston portion 444 is disposed in each of three spaces R. That is, these three piston portions 444 are arranged at intervals in the axial direction Da. The piston portion 444 has a disc shape that spreads around the axis O. The piston portion 444 extends in parallel to the partition portion 443 within the space R defined by the partition portion 443. The term “parallel” used herein means a substantially parallel relationship, and a slight inclination or the like is allowed if the relationship is substantially parallel. The side surface of the piston portion 444 is in sliding contact with the inner peripheral surface of the side portion 442a of the main body portion 442.

Here, the first sealing portion 447a is disposed between the side surface of the piston portion 444 and the inner peripheral surface of the side portion 442a. The first sealing portion 447a is an annular member centered on the axis O. The first sealing portion 447a is an elastic body. For example, an O-ring or the like is adopted for the first sealing portion 447a. The first sealing portion 447a comes into contact with each of the side surface of the piston portion 444 and the inner peripheral surface of the side portion 442a.

In this embodiment, the space R is divided into two spaces with the piston portion 444 as a boundary by the piston portion 444 and the first sealing portion 447a. These two spaces are isolated from each other such that the fluid F cannot flow through them. The space disposed on one side Dar in two divided spaces is the second space R2 to which the fluid F is supplied from the first space R1. The space disposed on the other side Dal in two spaces is a third space R3. The side portion 442a of the main body portion 442 is provided with an air release hole 442c which allows the third space R3 in the space R disposed on one side Dar and the space R disposed at the center among three spaces R arranged side by side in the axial direction Da to communicate with atmosphere. Thus, each third space R3 is maintained at an atmospheric pressure state.

Thus, the piston portion 444 is disposed in the space R and is movable in the axial direction Da while being in sliding contact with the inner peripheral surface of the side portion 442a of the main body portion 442 of the cylinder portion 441 in the space R in accordance with the supply of the fluid F to the second space R2.

(Piston Connection Portion)

The piston connection portion 445 connects together the second flange 20 and the piston portion 444 disposed on the most other side Dal among three piston portions 444 in the axial direction Da. The piston connection portion 445 has a columnar shape centered on the axial direction Da. The piston connection portion 445 is formed integrally with the piston portion 444 disposed on the most other side Dal.

(Rod Portion)

The rod portion 446 is a member that integrates three piston portions 444 in the axial direction Da. The rod portion 446 has a columnar shape extending in the axial direction Da. Here, a hole is formed at the center portion of each partition portion 443 to penetrate in the axial direction Da so that the rod portion 446 is insertable therethrough. The rod portion 446 is inserted through the hole of each partition portion 443. The outer peripheral surface of the rod portion 446 and the inner surface of the hole formed in the partition portion 443 are in sliding contact with each other.

The second sealing portion 447b is disposed between the outer peripheral surface of the rod portion 446 and the inner surface of the hole. The second sealing portion 447b is an annular member centered on the axis O. The second sealing portion 447b is an elastic body. For example, an O-ring or the like is adopted for the second sealing portion 447b. The second sealing portion 447b comes into contact with each of the outer peripheral surface of the rod portion 446 and the inner surface of the hole.

The rod portion 446 penetrates the center portion of the piston portion 444 disposed at the center among three piston portions 444 arranged side by side in the axial direction Da. The end portion on one side Dar of the rod portion 446 is connected to the piston portion 444 disposed on the most one side Dar among three piston portions 444. The end portion on the other side Dal of the rod portion 446 is connected to the piston portion 444 disposed on the most other side Dal among three piston portions 444. The rod portion 446 of this embodiment is formed integrally with each piston portion 444.

(Connection Portion)

The connection portion 43 connects together the elastic portion 42 and the first flange 10. The connection portion 43 is formed of, for example, a material such as metal. The connection portion 43 includes a first connecting arm 433, a second connecting arm 434, a support arm 435, and a fixing arm 436.

The first connecting arm 433 is connected to the piston section 440 of the elastic portion 42. The first connecting arm 433 includes a first connecting arm body 433a which extends in the axial direction Da and has a columnar shape and a first connection shaft 433b which is connected to the first connecting arm body 433a. The first connecting arm body 433a is connected to the bottom portion 442b of the main body portion 442 of the cylinder portion 441 from one side Dar. The first arm body extends from the surface facing one side Dar in the bottom portion 442b to one side Dar.

The first connection shaft 433b is disposed at the end portion on one side Dar of the first arm body. The first connection shaft 433b has a columnar shape extending in a direction intersecting the axial direction Da. The first connection shaft 433b of this embodiment extends in a direction perpendicular to the axial direction Da. In addition, “perpendicular” here means a substantially perpendicular relationship, and a slight inclination or the like is allowed in a substantially perpendicular relationship.

The second connecting arm 434 is connected to the first flange 10. The second connecting arm 434 is disposed on the inside of the first connecting arm 433 in the radial direction. The second connecting arm 434 includes a second connecting arm body 434a which extends in the axial direction Da and has a columnar shape and a second connection shaft 434b which is connected to the second connecting arm body 434a. The second connecting arm body 434a is connected to the first flange 10 from the other side Dal. The second connecting arm body 434a extends from the surface facing the other side Dal in the first flange 10 to the other side Dal. The dimension of the axial direction Da of the second connecting arm body 434a of this embodiment is larger than the dimension of the axial direction Da of the first connecting arm body 433a. The end portion on the other side Dal of the second connecting arm body 434a is located on the other side Dal in relation to the end portion on one side Dar of the first connecting arm body 433a.

The second connection shaft 434b is disposed at the end portion on the other side Dal of the second arm body. The second connection shaft 434b has a columnar shape extending in a direction intersecting the axial direction Da. The extension direction of the second connection shaft 434b is the same as the extension direction of the first connection shaft 433b. The term “same” used herein means substantially the same relationship, and a slight inclination or the like is allowed if the relationship is substantially the same.

The support arm 435 connects together the first connecting arm 433 and the second connecting arm 434. A first end portion 435a which is located on the outside in the radial direction of the support arm 435 is connected to the first connection shaft 433b of the first connecting arm 433 to be rotatable around this first connection shaft 433b. A second end portion 435b which is located on the inside in the radial direction of the main body of the support arm 435 is connected to the second connection shaft 434b of the second connecting arm 434 to be rotatable around this second connection shaft 434b.

The fixing arm 436 is connected to the second flange 20. The fixing arm 436 is disposed on the inside of the first connecting arm 433 in the radial direction and the outside of the second connecting arm 434 in the radial direction. The fixing arm 436 includes a fixing arm body 436a which extends in the axial direction Da and has a columnar shape and a rotary support shaft 436b. The fixing arm body 436a is connected to the second flange 20 from one side Dar. The fixing arm body 436a extends from the surface facing one side Dar in the second flange 20 to one side Dar.

The rotary support shaft 436b is disposed at the end portion on one side Dar of the fixing arm body 436a. The rotary support shaft 436b has a columnar shape extending in a direction intersecting the axial direction Da. The extension direction of the rotary support shaft 436b is the same as the extension direction of the first connection shaft 433b and the second connection shaft 434b. The term “same” used herein means substantially the same relationship, and a slight inclination or the like is allowed if the relationship is substantially the same. The rotary support shaft 436b is connected to the support arm 435. The rotary support shaft 436b supports the support arm 435 to be rotatable around this rotary support shaft 436b. The rotary support shaft 436b is disposed between the first end portion 435a and the second end portion 435b of the support arm 435.

Here, the radial dimension between the center of the rotary support shaft 436b and the center of the second connection shaft 434b is referred to as a “first length L1”. Further, the radial dimension between the center of the rotary support shaft 436b and the center of the first connection shaft 433b is referred to as a “second length L2”. That is, as shown in FIG. 4, the first length L1 is a length (dimension) of a projection line obtained when an imaginary line connecting the center of the rotary support shaft 436b and the center of the second connection shaft 434b is projected from the axial direction Da to an imaginary plane X that spreads in a direction perpendicular to the center axis Ar. The second length L2 is a length (dimension) of a projection line obtained when an imaginary line connecting the center of the rotary support shaft 436b and the center of the first connection shaft 433b is projected from the axial direction Da to the imaginary plane X that spreads in a direction perpendicular to the center axis Ar.

At this time, the rotary support shaft 436b is disposed at a position in which the moment applied to the first end portion 435a of the support arm 435 and the moment applied to the second end portion 435b of the support arm 435 are balanced. Specifically, the rotary support shaft 436b is disposed between the first end portion 435a and the second end portion 435b so that the following formula (I), that is, the formula (II) obtained by transforming the formula (I) is established by the relation between the first length L1 and the second length L2 when a force applied from the second connecting arm body 434a to the second end portion 435b of the support arm 435 in the axial direction Da (the other side Dal) is F1 and a force applied from the first connecting arm body 433a to the first end portion 435a of the support arm 435 in the axial direction Da (one side Dar) is F2.

F1L1=F2L2 (I)

F1/F2=L2/L1 (II)

In this embodiment, a link mechanism is configured by the first connecting arm 433, the second connecting arm 434, the support arm 435, and the fixing arm 436 of the above-described connection portion 43.

(Fluid Supply Unit)

The fluid supply unit 41 includes the flexible and bendable tube member 410 and the fluid passage 420.

The tube member 410 connects together the second straight pipe portion 32 of the main bellows 30 and the cylinder portion 441 of the piston section 440. One end of the tube member 410 is connected to the second straight pipe portion 32 so that the fluid F can be introduced from the first space R1 into the tube member 410. The other end of the tube member 410 is connected to the end portion 442e (end surface) on the other side of the side portion 442a of the main body portion 442.

Here, the fluid passage 420 which allows to supply the fluid F supplied from the tube member 410 into the second space R2 is formed in the cylinder portion 441. Specifically, the fluid passage 420 is formed inside each of the side portion 442a and the bottom portion 442b of the main body portion 442. The fluid passage 420 formed inside the side portion 442a and the fluid passage 420 formed inside the bottom portion 442b are connected to each other.

One end of the fluid passage 420 opens, for example, at the end portion 442e on the other side in the side portion 442a of the main body portion 442. One end of the fluid passage 420 is connected to the other end of the tube member 410. When starting from one end of the fluid passage 420 formed at the other end portion 442e of the side portion 442a, the fluid passage 420 is branched into three parts in the middle and the other ends of the three branched ends open into the second space R2.

Thus, the fluid supply unit 41 of this embodiment includes the tube member 410 and the fluid passage 420 formed inside the main body portion 442. By the fluid supply unit 41, the first space R1 and the second space R2 communicate with each other. The fluid F flowing through the first space R1 flows into the tube member 410 and then flows into the fluid passage 420 formed inside the main body portion 442. The fluid F flowing from the tube member 410 into the fluid passage 420 flows into the second space R2.

### Action and Effect

According to the above-described configuration, a part of the fluid F flowing through the first space R1 is supplied into the second space R2 through the fluid supply unit 41. When the fluid F is supplied into the second space R2, the piston portion 444 and the main body portion 442 of the cylinder portion 441 are displaced in the axial direction Da while being in sliding contact with each other. That is, the piston section 440 expands in the axial direction Da. As the piston section 440 expands, the first connecting arm body 433a connected to the bottom portion 442b from one side Dar is displaced to one side Dar. As the first connecting arm body 433a is displaced to one side Dar, the support arm 435 connected to the first connection shaft 433b rotates around the first connection shaft 433b with the first end portion 435a as a base point. At the same time, the support arm 435 rotates around the second connection shaft 434b connected to the second end portion 435b of the support arm 435 while being rotatably supported by (positioned to) the rotary support shaft 436b. In accordance with this rotation, the second connecting arm body 434a connected to the second connection shaft 434b pulls the first flange 10 to the other side Dal.

At this time, the rotary support shaft 436b is disposed at a position between the first end portion 435a and the second end portion 435b so that the moment applied to the first end portion 435a and the moment applied to the second end portion 435b are balanced. That is, even when the magnitude of the force applied from the second connecting arm body 434a to the second end portion 435b of the support arm 435 in the axial direction Da is different from the magnitude of the force applied from the first connecting arm body 433a to the first end portion 435a of the support arm 435 in the axial direction Da, the moment can be balanced by adjusting the first length L1 and the second length L2. Accordingly, the magnitude of the thrust force applied to the first flange 10 and the second flange 20 by the main bellows 30 and the magnitude of the opposite thrust force applied to the first flange 10 and the second flange 20 by the balancing device 40 can be balanced. For example, even when the thrust force applied to the first flange 10 and the second flange 20 in the axial direction Da by the main bellows 30 is larger than the force applied from the piston section 440 in the axial direction Da, both forces can be balanced by the connection portion 43 connected to the piston section 440. Thus, it is possible to suppress excessive load from being applied to the pipe 2 connected to the main bellows 30 due to the thrust force of the fluid F flowing through the first space R1.

### Third Embodiment

Next, a third embodiment of the expansion joint 1 according to the present disclosure will be described. Additionally, in the third embodiment described below, the configurations common to the first embodiment, the modified example of the first embodiment, and the second embodiment are denoted by the same reference numerals in the drawings, and a description thereof will be omitted. In the third embodiment, the configuration of the balancing device 40 is different from the configuration of the balancing device 40 described in the first embodiment, the modified example of the first embodiment, and the second embodiment.

(Balancing Device)

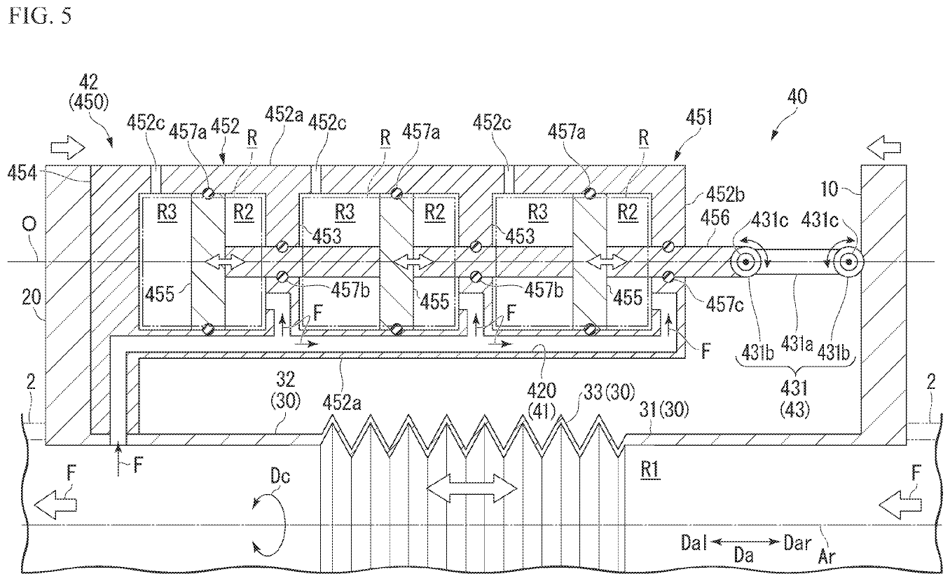

As shown in FIG. 5, the balancing device 40 includes the elastic portion 42, the connection portion 43, and the fluid supply unit 41.

(Elastic Portion)

The elastic portion 42 expands and contracts in the axial direction Da between the first flange 10 and the second flange 20. The elastic portion 42 is supplied with the fluid F from the outside and can be expanded and contracted in the axial direction Da according to the pressure of the supplied fluid F. The elastic portion 42 includes a piston section 450.

(Piston Section)

The piston section 450 is disposed between the first flange 10 and the second flange 20. The piston section 450 includes a cylinder portion 451, a piston portion 455, a rod portion 456, a cylinder fixing portion 454, a first sealing portion 457a, a second sealing portion 457b, and a third sealing portion 457c.

(Cylinder Portion)

The cylinder portion 451 includes a main body portion 452 and a partition portion 453. The main body portion 452 includes a side portion 452a which has a cylindrical shape centered on the axis O and a bottom portion 452b which is formed integrally with the side portion 452a to close the opening facing one side Dar in the side portion 452a and spreads in a disc shape around the axis O. The opening facing the other side Dal in the side portion 452a is closed by the cylinder fixing portion 454 from the other side Dal.

Here, the cylinder fixing portion 454 has a disc shape which spreads around the center axis Ar. The cylinder fixing portion 454 is fixed to the outer peripheral surface of the second straight pipe portion 32 and the surface facing one side Dar of the second flange 20 while surrounding the outer peripheral surface of the second straight pipe portion 32 of the main bellows 30 from the outside.

(Piston Portion)

The piston portion 455 is disposed in each of three spaces R. Here, the first sealing portion 457a is disposed between the side surface of the piston portion 455 and the inner peripheral surface of the side portion 452a. In this embodiment, the space R is divided by the piston portion 455 and the first sealing portion 457a into the second space R2 disposed on one side Dar and the third space R3 disposed on the other side Dal by using the piston portion 455 as a boundary. The side portion 452a of the main body portion 452 is provided with an air release hole 452c allowing each third space R3 to communicate with atmosphere.

(Rod Portion)

The rod portion 456 is a member that integrates three piston portions 455 in the axial direction Da. Here, a hole is formed at the center portion of the bottom portion 452b to penetrate in the axial direction Da so that the rod portion 456 is insertable therethrough. The rod portion 456 is inserted through the hole of each partition portion 453 and the hole of the bottom portion 452b. The outer peripheral surface of the rod portion 456 and the inner surface of the hole are in sliding contact with each other.

The third sealing portion 457c is disposed between the outer peripheral surface of the rod portion 456 and the inner surface of the hole of the bottom portion 452b. The third sealing portion 457c is an annular member centered on the axis O. The third sealing portion 457c is an elastic body. For example, an O-ring or the like is adopted for the third sealing portion 457c. The third sealing portion 457c comes into contact with each of the outer peripheral surface of the rod portion 456 and the inner surface of the hole of the bottom portion 452b.

The rod portion 456 penetrates the center portion of the piston portion 455 disposed on one side Dar among three piston portions 455 arranged side by side in the axial direction Da and the center portion of the piston portion 455 disposed at the center. Further, the end portion on one side Dar of the rod portion 456 protrudes to one side Dar in relation to the bottom portion 452b.

(Connection Portion)

The connection portion 43 connects together the elastic portion 42 and the first flange 10. The connection portion 43 includes the first connection portion 431 which connects together the first flange 10 and the elastic portion 42. The first connection portion 431 includes the first arm portion 431a and the first joint portion 431b. The first arm portion 431a is disposed between the first flange 10 and the piston section 450 of the elastic portion 42. In two first joint portions 431b connected to the first arm portion 431a, the first joint portion 431b disposed on one side Dar is connected to the first flange 10. In two first joint portions 431b connected to the first arm portion 431a, the first joint portion 431b disposed on the other side Dal is connected to the end portion on one side Dar of the rod of the piston section 450.

(Fluid Supply Unit)

The fluid supply unit 41 includes the fluid passage 420 through which the fluid F flowing in the first space R1 can be supplied into the second space R2. The fluid passage 420 is formed on the inside of each of the side portion 452a and the bottom portion 452b of the main body portion 452 of the cylinder portion 451 and the inside of the cylinder fixing portion 454. The fluid passages 420 respectively formed in the side portion 452a, the bottom portion 452b, and the cylinder fixing portion 454 are connected to each other.

One end of the fluid passage 420 opens, for example, at a portion fixed to the outer peripheral surface of the second straight pipe portion 32 in the cylinder fixing portion 454. One end of the fluid passage 420 is connected to the hole formed in the second straight pipe portion 32 to extract the fluid F from the first space R1 to the outside. When starting from one end of the fluid passage 420, the fluid passage 420 is branched into three parts in the middle and the other ends of the three branched ends open into the second space R2.

### Action and Effect

According to the above-described configuration, a part of the fluid F flowing through the first space R1 is supplied to the second space R2 through the fluid supply unit 41. When the fluid F is supplied into the second space R2, the piston portion 455 and the main body portion 452 of the cylinder portion 451 are displaced in the axial direction Da while being in sliding contact with each other. Each of the piston portion 455 and the rod portion 456 is displaced to the other side Dal. As each of the piston portion 455 and the rod portion 456 is displaced, the first connection portion 431 connected to the end portion on one side Dar of the rod portion 456 from one side Dar is displaced to the other side Dal. As a result, the first flange 10 connected to the first connection portion 431 is pulled to one side Dar. Accordingly, the same effects as those of the above-described embodiment can be obtained.

### OTHER EMBODIMENTS

As described above, the embodiments of the present disclosure have been described in detail with reference to the drawings, but the specific configuration is not limited to the configurations of the embodiments and additions, omissions, substitutions, and other changes of the configurations are possible without departing from the gist of the present disclosure.

Additionally, in the first embodiment, an example of a configuration in which the first structure 421 of the elastic portion 42 includes four first plate portions 421b and the second structure 422 includes four second plate portions 422b has been described, but the present disclosure is not limited to this configuration. For example, the first structure 421 may include two or more, three or less, or five or more first plate portions 421b and the second structure 422 may include the same number of the second plate portions 422b as the number of the first plate portions 421b of the first structure 421. At this time, the number of the small bellows 423 corresponding to the “number of the first plate portions 421b of the first structure 421-1” may be disposed between the first plate portion 421b and the second plate portion 422b. The same applies to the number of arrangement of the piston sections 430 described in the modified example of the first embodiment.

Further, in the first embodiment, a configuration in which the first support column 421a of the first structure 421 is fixed to each first plate portion 421b by the first fixing nut 42a and the second support column 422a of the second structure 422 is fixed to each second plate portion 422b by the second fixing nut 42b has been described, but the present disclosure is not limited to this configuration. For example, the first support column 421a may be fixed to each first plate portion 421b by welding or the like. The second support column 422a may be fixed to each second plate portion 422b by welding or the like. Further, the first support column 421a and the first plate portion 421b, and the second support column 422a and the second plate portion 422b may be integrally formed from the beginning during the manufacturing stage.

Further, a part of the small bellows 423 among the plurality of small bellows 423 described in the first embodiment may be replaced with the piston section 450 described in the modified example of the first embodiment.

Further, the first connection portion 431 described in the first embodiment may be a columnar member that simply connects together the first flange 10 and the second plate portion 422b disposed on the most one side Dar of the second structure 422 without having the first joint portion 431b. At this time, the second connection portion 432 includes the second arm portion 432a and the second joint portion 432b. Further, the second connection portion 432 may be a member that simply connects together the second flange 20 and the first plate portion 421b disposed on the most other side Dal of the first structure 421 without using the second joint portion 432b. At this time, the first connection portion 431 includes the first arm portion 431a and the first joint portion 431b. Thus, at least one of the first connection portion 431 and the second connection portion 432 may have the configuration described in the embodiment.

Further, the first connection portion 431 described in the first embodiment and the third embodiment may include the plurality of first arm portions 431a and the first joint portion 431b connecting the first arm portions 431a together. At this time, the first joint portion 431b may be connected to both ends of the first arm portions 431a arranged at both ends in the arrangement direction of the plurality of first arm portions 431a. Further, the second connection portion 432 described in the first embodiment may include the plurality of second arm portions 432a and the second joint portion 432b connecting the second arm portions 432a together. At this time, the second joint portion 432b may be connected to both ends of the second arm portion 432a arranged at both ends of the plurality of second arm portions 432a in the arrangement direction.

Further, in the first embodiment and the third embodiment, a configuration in which the first joint portion 431b of the first connection portion 431 is a universal joint has been described, but the present disclosure is not limited to this configuration. For example, the first joint portion 431b of the first connection portion 431 may be a ball joint. Further, in the first embodiment, a configuration in which the second joint portion 432b of the second connection portion 432 is a universal joint has been described, but the present disclosure is not limited to this configuration. For example, the second joint portion 432b of the second connection portion 432 may be a ball joint.

Further, the configuration of the fluid supply unit 41 described in the first embodiment is not limited to the above. For example, the fluid supply unit 41 may have a configuration in which the tube member 410 directly connects together the main bellows 30 and the small bellows 423 without having the fluid passage 420. Further, the configuration of the fluid supply unit 41 described in the modified example of the first embodiment is not limited to the above. For example, the fluid supply unit 41 may have a configuration in which the tube member 410 directly connects together the main bellows 30 and the piston section 430 without having the fluid passage 420. Further, the configuration of the fluid supply unit 41 described in the second embodiment and the third embodiment is not limited to the above. For example, the fluid supply unit 41 may have a configuration in which the tube member 410 directly connects together the main bellows 30 and the piston sections 440 and 450 without having the fluid passage 420.

Further, in the first embodiment, a configuration in which the fluid passage 420 of the fluid supply unit 41 is formed inside the second support column 422a and the second plate portion 422b of the second structure 422 has been described, but the present disclosure is not limited to this configuration. For example, the fluid supply pipe may be disposed inside each of the second support column 422a and the second plate portion 422b and the inside of this pipe may be referred to as the fluid passage 420. Further, in the second embodiment, a configuration in which the fluid passage 420 of the fluid supply unit 41 is formed inside each of the side portion 442a and the bottom portion 442b of the main body portion 442 of the cylinder portion 441 has been described, but the present disclosure is not limited to this configuration. For example, the fluid supply pipe may be disposed inside each of the side portion 442a and the bottom portion 442b and the inside of this pipe may be referred to as the fluid passage 420. Further, in the third embodiment, a configuration in which the fluid passage 420 of the fluid supply unit 41 is disposed inside each of the side portion 452a and the bottom portion 452b of the main body portion 452 of the cylinder portion 451 and the cylinder fixing portion 454 has been described, but the present disclosure is not limited to this configuration. For example, the fluid supply pipe may be disposed inside each of the side portion 452a, the bottom portion 452b, and the cylinder fixing portion 454 and the inside of this pipe may be referred to as the fluid passage 420.

Further, in the first embodiment, a configuration in which the fluid passage 420 of the fluid supply unit 41 is formed inside the second support column 422a and the second plate portion 422b of the second structure 422 has been described, but the present disclosure is not limited to this configuration. For example, the fluid passage 420 may be formed inside the first support column 421a and the first plate portion 421b of the first structure 421.

Further, in the first embodiment, a configuration in which the tube member 410 of the fluid supply unit 41 is connected to the first straight pipe portion 31 has been described, but the present disclosure is not limited to this configuration. The tube member 410 may be connected to the second straight pipe portion 32 or the bellows portion 33 so that the fluid F can be extracted from the first space R1 to the outside. Further, in the second embodiment and the third embodiment, a configuration in which the tube member 410 of the fluid supply unit 41 is connected to the second straight pipe portion 32 has been described, but the present disclosure is not limited to this configuration. The tube member 410 may be connected to the first straight pipe portion 31 or the bellows portion 33 so that the fluid F can be extracted from the first space R1 to the outside.

Further, in the second embodiment, a configuration in which the second connecting arm 434 is disposed on the inside in the radial direction in relation to the first connecting arm 433 has been described, but the present disclosure is not limited to this configuration. For example, the second connecting arm 434 may be disposed on the outside in the radial direction in relation to the first connecting arm 433. At this time, the fixing arm 436 is disposed on the outside in the radial direction in relation to the first connecting arm 433 and the inside in the radial direction in relation to the second connecting arm 434.

Further, in the second embodiment, a configuration in which the fixing arm body 436a is connected to the second flange 20 and extends from the surface facing one side Dar of the second flange 20 to one side Dar has been described, but the present disclosure is not limited to this configuration. The fixing arm body 436a may be connected to the first flange 10 and extend from the surface facing the other side Dal of the first flange 10 to the other side Dal. At this time, the rotary support shaft 436b is disposed at the end portion on the other side Dal in the fixing arm body 436a.

Further, in the second embodiment, the first connection portion 431 described in the first embodiment may be disposed between the first flange 10 and the second connecting arm 434. At this time, the first joint portion 431b connected to the end portion on one side Dar of the first arm portion 431a of the first connection portion 431 is connected to the first flange 10 from the other side Dal. The first joint portion 431b connected to the end portion on the other side Dal of the first arm portion 431a is connected to the second connecting arm body 434a of the second connecting arm 434 from one side Dar.

Further, in the second embodiment and the third embodiment, a configuration in which the cylinder portions 441 and 451 include two partition portions 443 and 453 has been described, but the present disclosure is not limited to this configuration. For example, the cylinder portions 441 and 451 may include one or three or more partition portions 443 and 453. That is, the inside of the cylinder portions 441 and 451 may be defined into two spaces R or four or more spaces R. Further, the cylinder portions 441 and 451 may not include the partition portions 443 and 453. At this time, one space R is formed inside the main body portions 442 and 452. In such a case, the piston portions 444 and 455 may be arranged inside the space R and the space R may be divided into the second space R2 and the third space R3 by using the piston portions 444 and 455 as a boundary. Thus, the piston sections 440 and 450 may include the same number of piston portions 444 and 455 as the number of the spaces R defined inside the cylinder portions 441 and 451.

Further, in each of the above-described embodiments, a configuration in which the first flange 10 and the second flange 20 are formed in a disc shape centered on the center axis Ar, but the present disclosure is not limited to this configuration. The first flange 10 and the second flange 20 may be formed in, for example, a polygonal shape centered on the center axis Ar. The first flange 10 and the second flange 20 may be connected to the main bellows 30 while spreading in a flange shape with respect to the main bellows 30.

Further, in each of the above-described embodiments, the expansion joint 1 connects together two fluid pipes arranged between the scrolls in the geared compressor, but the present disclosure is not limited to this configuration. For example, the expansion joint 1 may be used to connect the fluid pipes of the gas turbine. The expansion joint 1 may be used for the purpose of connecting two fluid pipes through which the high-pressure fluid F flows.

Further, the configurations of the expansion joints 1 described in the above-described embodiments are not limited to independent configurations. The expansion joint 1 may be configured by appropriately combining the constituent elements described in each embodiment.

### APPENDIX

The expansion joints and the balancing devices described in each embodiment are understood, for example, as follows.

(1) An expansion joint 1 according to a first aspect is an expansion joint 1 connecting two pipes allowing a fluid F to flow therethrough, the expansion joint including: a first flange 10 which is disposed outside the pipe 2 around a center axis Ar of the expansion joint 1; a second flange 20 which is disposed outside the pipe 2 around the center axis Ar and is disposed away from the first flange 10 in an axial direction Da in which the center axis Ar extends; a main bellows 30 which is connected to the first flange 10 and the second flange 20 and has a flow passage formed therein so that the fluid F is able to flow therethrough; and a balancing device 40 which is connected to the first flange 10 and the second flange 20 outside the main bellows 30 and applies a thrust force opposite to a thrust force, applied to the first flange 10 and the second flange 20 in the axial direction Da by the main bellows 30, to the first flange 10 and the second flange 20, wherein the balancing device 40 includes a fluid supply unit 41 which is configured to supply the fluid F, an elastic portion 42 which is connected to the fluid supply unit 41 and is able to expand and contract in the axial direction Da along an axis O extending in parallel to the center axis Ar according to the pressure of the supplied fluid F, and a connection portion 43 connecting the elastic portion 42 to the first flange 10 and the second flange 20.

Accordingly, the fluid F is supplied from the flow passage inside the main bellows 30 to the elastic portion 42 and the elastic portion 42 expands and contracts in the axial direction Da. As the elastic portion 42 expands and contracts, the connection portion 43 pulls the first flange 10 and the second flange 20 toward each other in the axial direction Da. Thus, a thrust force opposite to the thrust force applied to the first flange 10 and the second flange 20 by the main bellows 30 is applied to the first flange 10 and the second flange 20 due to the balancing device 40.

(2) The expansion joint 1 according to a second aspect is the expansion joint 1 according to the first aspect, wherein the elastic portion 42 may include a small bellows 423 which is allowed to expand and contract in the axial direction Da according to the pressure of the supplied fluid F, wherein the small bellows 423 is smaller than the main bellows 30.

Accordingly, the above action can be realized with a more specific configuration. Further, the elastic portion 42 can be expanded and contracted by a simple member such as the small bellows 423.

(3) The expansion joint 1 according to a third aspect is the expansion joint 1 according to the first or second aspect, wherein the elastic portion 42 may include piston sections 430, 440, and 450 which is configured to expand and contract in the axial direction Da according to the pressure of the supplied fluid F.

Accordingly, the above action can be realized with a more specific configuration. Further, the elastic portion 42 can be expanded and contracted by the simple-structured piston section.

(4) The expansion joint 1 according to a fourth aspect is the expansion joint 1 according to the third aspect, wherein the piston sections 440 and 450 may include cylinder portions 441 and 451 which are formed in a bottomed cylindrical shape centered on the axis O and has a plurality of spaces R defined therein, a plurality of piston portions 444 and 455 which are respectively arranged inside the spaces R and are movable in the axial direction Da while being in sliding contact with inner peripheral surfaces of the cylinder portions 441 and 451 inside the spaces R in accordance with the supply of the fluid F, and rod portions 446 and 456 which are connected to the plurality of piston portions 444 and 455.

Accordingly, the above action can be realized with a more specific configuration.

(5) The expansion joint 1 according to a fifth aspect is the expansion joint 1 according to any one of the first to fourth aspects, wherein the connection portion 43 may include a first connection portion 431 which is connected to the first flange 10 and a second connection portion 432 which is connected to the second flange 20, and wherein at least one of the first connection portion 431 and the second connection portion 432 may include an arm portion extending in the axial direction Da and a joint portion rotatably supporting the arm portion by a rotating shaft extending in a direction intersecting the axial direction Da.

Accordingly, when the main bellows 30 is displaced in a direction perpendicular to the axial direction Da, the first arm portion 431a is rotated by the first joint portion 431b and the second arm portion 432a is rotated by the second joint portion 432b to follow the displacement.

(6) The expansion joint 1 according to a sixth aspect is the expansion joint 1 according to any one of the first to fifth aspects, wherein the connection portion 43 may include a first connecting arm 433 which is connected to the elastic portion 42, a second connecting arm 434 which is connected to one of the first flange 10 and the second flange 20, and a support arm 435 which is supported to be rotatable around a rotary support shaft 436b extending in a direction intersecting the axial direction Da at a position in which the first end portion 435a is connected to the first connecting arm 433, the second end portion 435b is connected to the second connecting arm 434, and the first end portion 435a and the second end portion 435b are away from each other, wherein the rotary support shaft 436b may be disposed at a position between the first end portion 435a and the second end portion 435b so that a moment applied to the first end portion 435a and a moment applied to the second end portion 435b are balanced.

Accordingly, for example, even when a thrust force applied to the first flange 10 and the second flange 20 in the axial direction Da by the main bellows 30 is larger than a force applied from the elastic portion 42 in the axial direction Da, both forces can be balanced by the connection portion 43.

(7) The expansion joint 1 according to a seventh aspect is the expansion joint 1 according to any one of the first to sixth aspects, wherein the fluid supply unit 41 may include a flexible and bendable tube member 410.

Accordingly, the above action can be realized with a more specific configuration.

(8) The expansion joint 1 according to an eighth aspect is the expansion joint 1 according to any one of the first to seventh aspects, wherein the plurality of balancing devices 40 may be arranged outside the main bellows 30 away from each other in a circumferential direction Dc around the center axis Ar.

Accordingly, the thrust forces applied to the pipe 2 can be suppressed in a balanced manner.

(9) A balancing device 40 according to a ninth aspect is a balancing device 40 that is disposed outside a body of an expansion joint 1 including a first flange 10 which is disposed outside a pipe 2 around a center axis Ar, a second flange 20 which is disposed outside the pipe 2 around the center axis Ar and is disposed away from the first flange 10 in an axial direction Da in which the center axis Ar extends, and a main bellows 30 which is connected to the first flange 10 and the second flange 20 and has a flow passage formed therein so that a fluid F is able to flow therethrough and connecting two pipes 2 through which the fluid F flows, the balancing device including: a fluid supply unit 41 which is configured to supply the fluid F; an elastic portion 42 which is connected to the fluid supply unit 41 and is able to expand and contract in the axial direction Da along an axis O extending in parallel to the center axis Ar according to the pressure of the supplied fluid F; and a connection portion 43 connecting the elastic portion 42 to the first flange 10 and the second flange 20, wherein when the elastic portion 42 is disposed outside the main bellows 30 and expands and contracts, a thrust force opposite to a thrust force applied to the first flange 10 and the second flange 20 in the axial direction Da by the main bellows 30 is applied to the first flange 10 and the second flange 20.

### EXPLANATION OF REFERENCES

1 Expansion joint
2 Pipe
10 First flange
20 Second flange
30 Bellows
31 First straight pipe portion
32 Second straight pipe portion
33 Bellows portion
40 Balancing device
41 Fluid supply unit
42 Elastic portion
42a First fixing nut
42b Second fixing nut
43 Connection portion
300 Straight pipe portion
410 Tube member
420 Fluid passage
421 First structure
421a First support column
421b First plate portion
421c First surface
421d Second surface
422 Second structure
422a Second support column
422b Second plate portion
422c One surface
422d Other surface
423 Small bellows
430, 440, 450 Piston section
430a Inner tube
430b Outer tube
431 First connection portion
431a First arm portion
431b First joint portion
431c First rotating shaft
432 Second connection portion
432a Second arm portion
432b Second joint portion
432c Second rotating shaft
433 First connecting arm
433a First connecting arm body
433b First connection shaft
434 Second connecting arm
434a Second connecting arm body
434b Second connection shaft
435 Support arm
435a First end portion
435b Second end portion
436 Fixing arm
436a Fixing arm body
436b Rotary support shaft
441, 451 Cylinder portion
442, 452 Main body portion
442a, 452a Side portion
442b, 452b Bottom portion
442c, 452c Air release hole
442e End portion
443, 453 Partition portion
444, 455 Piston portion
445 Piston connection portion
446, 456 Rod portion
447, 457 Sealing portion
447a, 457a First sealing portion
447b, 457b Second sealing portion
454 Cylinder fixing portion
457c Third sealing portion
Ar Center axis
Da Axial direction
Dal Other side
Dar One side
Dc Circumferential direction
F Fluid
L1 First length
L2 Second length
O Axis
R Space
R1 First space
R2 Second space
R3 Third space
X imaginary plane

What is claimed is:

1. An expansion joint connecting two pipes allowing a fluid to flow therethrough, the expansion joint comprising:
a first flange which is disposed outside the pipe around a center axis of the expansion joint;
a second flange which is disposed outside the pipe around the center axis and is disposed away from the first flange in an axial direction in which the center axis extends;
a main bellows which is connected to the first flange and the second flange and has a flow passage formed therein so that the fluid is able to flow therethrough; and
a balancing device which is connected to the first flange and the second flange outside the main bellows and applies a thrust force opposite to a thrust force, applied to the first flange and the second flange in the axial direction by the main bellows, to the first flange and the second flange,
wherein the balancing device includes a fluid supply unit which is configured to supply the fluid, an elastic portion which is connected to the fluid supply unit and is able to expand and contract in the axial direction along an axis extending in parallel to the center axis according to a pressure of the supplied fluid, and a connection portion connecting the elastic portion to the first flange and the second flange.

2. The expansion joint according to claim 1,
wherein the elastic portion includes a small bellows which is allowed to expand and contract in the axial direction according to the pressure of the supplied fluid, wherein the small bellows is smaller than the main bellows.

3. The expansion joint according to claim 1,
wherein the elastic portion includes a piston section which is configured to expand and contract in the axial direction according to the pressure of the supplied fluid.

4. The expansion joint according to claim 3,
wherein the piston section includes a cylinder portion which is formed in a bottomed cylindrical shape centered on the axis and has a plurality of spaces defined therein, a plurality of piston portions which are respectively arranged inside the spaces and are movable in the axial direction while being in sliding contact with an inner peripheral surface of the cylinder portion inside the space in accordance with the supply of the fluid, and a rod portion which is connected to the plurality of piston portions.

5. The expansion joint according to claim 1,
wherein the connection portion includes a first connection portion which is connected to the first flange and a second connection portion which is connected to the second flange, and
wherein at least one of the first connection portion and the second connection portion includes an arm portion extending in the axial direction and a joint portion rotatably supporting the arm portion by a rotating shaft extending in a direction intersecting the axial direction.

6. The expansion joint according to claim 1,
wherein the connection portion includes a first connecting arm which is connected to the elastic portion, a second connecting arm which is connected to one of the first flange and the second flange, and a support arm which is supported to be rotatable around a rotary support shaft extending in a direction intersecting the axial direction at a position in which a first end portion is connected to the first connecting arm, a second end portion is connected to the second connecting arm, and the first end portion and the second end portion are away from each other, and
wherein the rotary support shaft is disposed at a position between the first end portion and the second end portion so that a moment applied to the first end portion and a moment applied to the second end portion are balanced.

7. The expansion joint according to claim 1,
wherein the fluid supply unit includes a flexible and bendable tube member.

8. The expansion joint according to claim 1,
wherein a plurality of the balancing devices are arranged outside the main bellows away from each other in a circumferential direction around the center axis.

9. A balancing device that is disposed outside an expansion joint body including a first flange which is disposed outside a pipe around a center axis, a second flange which is disposed outside the pipe around the center axis and is disposed away from the first flange in an axial direction in which the center axis extends, and a main bellows which is connected to the first flange and the second flange and has a flow passage formed therein so that a fluid is able to flow therethrough and connecting two pipes through which the fluid flows, the balancing device comprising:
a fluid supply unit which is configured to supply the fluid;
an elastic portion which is connected to the fluid supply unit and is able to expand and contract in the axial direction along an axis extending in parallel to the center axis according to the pressure of the supplied fluid; and
a connection portion connecting the elastic portion to the first flange and the second flange,
wherein when the elastic portion is disposed outside the main bellows and expands and contracts, a thrust force opposite to a thrust force applied to the first flange and the second flange in the axial direction by the main bellows is applied to the first flange and the second flange.
